(19) United States
(12) Patent Application Publication
(10) Pub. No.: US 2005/0262172 A1
(43) Pub. Date: Nov. 24, 2005

(54) Media management system and methods with status interface

(76) Inventors: Stephen Gold, Fort Collins, CO (US); Robert M. Gibson, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/130,982

(22) Filed: May 16, 2005

Related U.S. Application Data
(60) Provisional application No. 60/573,452, filed on May 21, 2004.

(51) Int. Cl. G06F 17/30

(52) U.S. Cl. 707/204

(57) ABSTRACT

A media management system includes a first media manager and a second media manager. A status interface system operatively associated with the first and second media managers allows a status of the second media manager to be communicated to the first media manager.

### REFERENCE TO CO-PENDING PROVISIONAL APPLICATION

Applicants hereby claim the benefit of an earlier filed co-pending provisional application, Application No. 60/573,452, filed on May 21, 2004, which is incorporated herein by reference for all that it discloses.

### BACKGROUND

The management of media used to backup data can be a complex process. Media jobs need to be performed on a routine basis. These media jobs may fall into different categories, such as media movement jobs that move media to a different location, device load jobs to load media into backup devices, and scratch initialization jobs to make media available for use by a backup application.

While media management systems have been developed to manage certain aspects of such media jobs, they are typically limited to the management of media jobs within certain defined environments. Problems can arise if the media leaves the managed environment. For example, many media management systems are capable of managing media jobs up to the point where the media are in their final destination locations. However, subsequent movements of the media outside of this environment (e.g., if the media are subsequently sent to an offsite location or vender) cannot be managed by the media management system. That is, the media management system cannot tell when or if the media are successfully stored or retrieved from the offsite location or vender.

### SUMMARY OF THE INVENTION

A media management system according to one embodiment of the invention may comprise a first media manager and a second media manager. A status interface system operatively associated with the first and second media managers allows a status of the second media manager to be communicated to the first media manager.

Also disclosed is a method for managing the first media management system and the second media management system that comprises: Receiving status information from the second media manager; and transferring the status information to the first media manager.

### BRIEF DESCRIPTION OF THE DRAWINGS

Illustrative and presently preferred exemplary embodiments of the invention are shown in the drawings in which:

FIG. 1 is a high-level block diagram of one embodiment of a media management system;

FIG. 2 is a flow diagram of one embodiment of a media management method;

FIG. 3 is an exemplary status request file entitled “Job Status XML;”

FIG. 4 is an exemplary status request file entitled “Job Status DTD;”

FIG. 5 is a sample status information file entitled “Status Results XML;” and

FIGS. 6a and 6b together illustrate a sample status information file entitled “Status Results DTD.”

### DETAILED DESCRIPTION

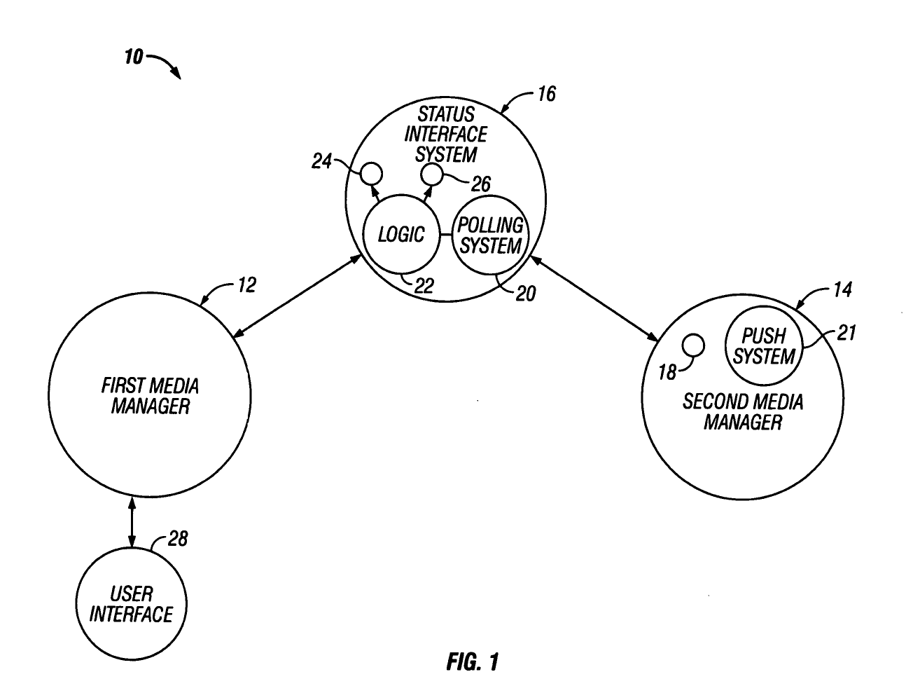

A media management system 10 with status interface is illustrated in FIG. 1 and may comprise a first media manager 12, a second media manager 14, and a status interface system 16. The status interface system 16 is operatively associated with the first media manager 12 and the second media manager 14 and allows a status of the second media management system 14 (also referred to herein as “status information 18”) to be communicated from the second media manager 14 to the first media manager 12. In one embodiment, the status interface system 16 is provided with a polling system 20 which polls the second media manager 14 for the status information 18. The status interface system 16 may also be provided with logic 22 for performing the various functions and operations described herein. For example, and as will be described in greater detail below, the logic 20 may be used to transfer the status information 18 to the first media manager 12. The logic 22 may also be used to classify the status information 18 to produce classified status information 24. In one embodiment, the status information 18 is further processed by logic 22 to produce supplemental status information 26.

The first media manager 12 may receive the status information 18, the classified status information 24, and supplemental status information 26 from the status interface system 16. Thereafter, the first media manager 12 may present certain of the information, or parts of the certain information (e.g., status information 18, classified status information 24, or supplemental status information 26, or some combination thereof) on a user interface 28 operatively associated with the first media manager. In addition, the first media manager 12 may take certain steps or initiate various processes based on the information received from the status interface system 16.

For example, in one embodiment, the first media manager 12 provides policy-based management of media which might involve media being sent or retrieved to the second media manager 14. The policy-based management of media is also referred to herein as a service level agreement (SLA). The SLA may also involve how media movement jobs are electronically sent to the second media manager 14. The media management system 10, by receiving status information 18 from the second media manager 14 and transmitting it to the first media manager 12, allows the SLA to be tracked by the first media manager 12 to the end of the media management chain, i.e., in this example to the second media manager 14. The ability of the first media manager 12 to track the SLA provides significant advantages in media management.

For example, if the first media manager 12 sends a job request to the second media manager 14, the status interface system 16 will poll the second media manager 14 for information (i.e., status information 18) relating to the status of the job. In addition, and as will be described in greater detail below, the status interface system 16 may poll the second media manager 14 for status information 18 for any job performed by the second media manager 14 for the first media manager 12. If the job for which the status information 18 is requested is successfully completed by the second media manager 14, the status information 18 will be indicative of such a successful completion. Thereafter, the first media manager 12 may utilize this information accordingly. Alternatively, if the job was not successfully completed, suitable actions can be taken by the first media manager 12. For example, in one embodiment one action might be to inform a user (not shown) of the problem, e.g., via the user interface 28. Alternatively, the first media manager 12 may take other actions on its own initiative to attempt to resolve the problem. A still further action may be for the first media manager 12 to inform the second media manager 14 of the problem.

Having briefly described the media managing system 10 with status interface, as well as certain of its features and advantages, the various embodiments of the media managing system 10 will now be described in detail. However, before proceeding with the description, it should be noted that while the media managing system 10 is shown and described herein as it could be utilized with first and second media managers 12 and 14, it is not limited to any particular number of media managers, nor any particular arrangement of the media managers. Indeed, as is known, many media manager systems are complex and involve a substantial number of separate media managers located at many different locations. Consequently, the present invention should not be regarded as limited to the particular configurations shown and described herein.

In addition, the status information 18 acquired by the status information system 16 of the media management system 10 may be utilized in any of a wide variety of ways, again depending on the particular type and configuration of the overall media manager system. Consequently, the present invention should not be regarded as limited to the particular applications and functions shown and described herein.

It should also be noted that the media managing system 10, and the various components and functions thereof, may be implemented in software, firmware, hardware, or some combination thereof. In addition, the various components and functions may reside at separate physical locations, such as separate servers.

With reference back now to FIG. 1, one embodiment of the media management system 10 with status interface is shown and described herein as it could be used in conjunction with a first media manager 12 and a second media manager 14. By way of example, in one embodiment, the first media manager 12 may comprise a policy-based media management system such as the type shown and described in commonly-owned U.S. patent application Ser. No. 10/684,013, filed on Oct. 10, 2003, entitled “Media Vaulting,” which is specifically incorporated herein by reference for all that it discloses. Alternatively, other types of media managers 12 may also be used.

The second media manager 14 may also comprise a policy-based media management system and, in the embodiment shown and described herein, may be substantially identical to the first media manager 12, although this is not required.

The media management system 10 also comprises a status interface system 16. The status interface system 16 is operatively associated with the first and second media managers 12 and 14, respectively, and allows a status of the second media manager 14 (i.e., status information 18) to be communicated or transferred to the first media manager system 12. In one embodiment, the status interface system 16 is provided with a polling system 20. In the embodiment shown and described herein, the polling system 20 periodically polls (e.g., every 10 minutes) the second media manager 14 for the status information 18. Alternatively, other arrangements are possible for providing the status information 18 to the status interface system 16. For example, in another embodiment, the second media manager 14 may be provided with a push system 21 for “pushing” the status information 18 to the status interface system 16.

The status interface system 16 may also be provided with logic 22 for performing the various functions and operations described herein. By way of example, and as will be described in greater detail below, the logic 22 may be used to transfer the status information 18 to the first media manager 12. The logic 22 may also be used to classify the status information 18 to produce classified status information 24. As will be described in greater detail below, the logic 22 may be used to further process the status information 18 to produce supplemental status information 26.

As mentioned above, the media management system 10 with status interface allows the first media manager 12 to monitor jobs running on other media managers, such as second media manager 14. In this particular context, the first media manager 12 also may be referred to herein as the initiating media manager 12. The other media manager or managers, such as second media manager 14, may also be referred to herein as “offsite” media managers. However, it should be noted that the term “offsite” refers to the logical, rather than the physical location of such other media manager systems. Depending on the configuration of the particular media management system 10, the offsite media manager (e.g., the second media manager 14) could be located immediately adjacent the initiating media manager (e.g., the first media manager 12). Similarly, jobs running on an offsite media manager (e.g., second media manager 14) are referred to herein as “offsite jobs,” regardless of whether such jobs were initiated by the initiating media manager (e.g., the first media manager 12).

In the embodiment shown and described herein, the media management system 10 uses the status information 18 to determine the status of, among other things, the offsite jobs. The media management system 10 may then take certain actions based on the status of the offsite jobs. For example, if the media management system 10 determines whether certain offsite jobs initiated by the initiating media manager (e.g., the first media manager 12) were successfully completed by the offsite media manager (e.g., the second media manager 14). If they were not, the media management system 10 retries the original job request. The media management system 10 may also be used to monitor the running offsite jobs and detect when they have been completed. In this regard, the media management system 10 may also detect when offsite jobs have been completed with errors, e.g., involved “lost” media (i.e., media that was required by the job, but could not be found) or “unexpected” media (i.e., media that arrived at the offsite media manager 14 but was not listed on any of the offsite jobs).

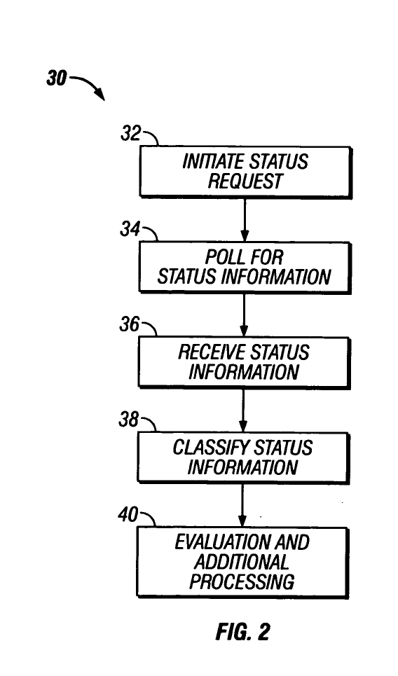

With reference now primarily to FIG. 2, a media management method 30 begins by initiating a status request 32. A status request may be initiated by the media management system 10 at any convenient time and at generally regular intervals, although regular intervals are not required. By way of example, in one preferred embodiment, a status request may be initiated every 10 minutes. It is generally preferred, but not required, that a status request be generated for each outstanding (i.e., not completed) offsite job.

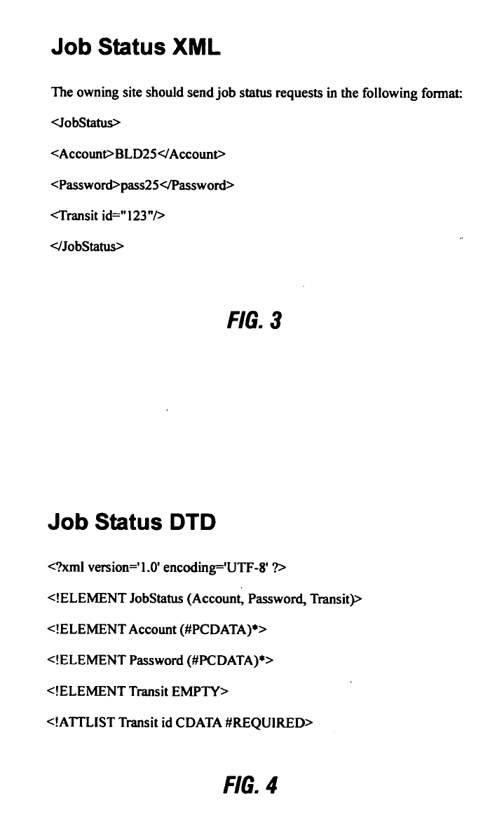

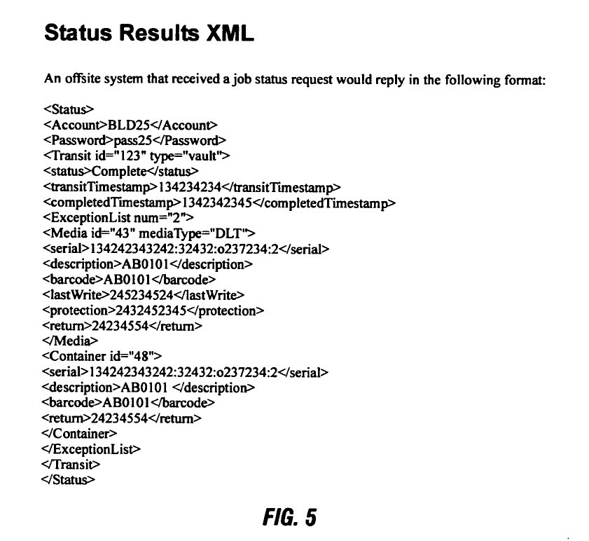

In one embodiment, the status request is based on the standard HTTPS protocol, where each status request is in XML format. Exemplary status request files are illustrated in FIGS. 3 and 4. Because the HTTPS protocol is capable of communications via proxy servers, it allows the first media manager 12 to communicate through a firewall in order to connect to the second media manager 14.

With reference now to FIGS. 3 and 4, the status request may include authentication data (e.g., an account number and password) as well as job identification data (e.g., a transit ID). For example, if the first media manager 12 comprises the type disclosed un U.S. patent application Ser. No. 10/684,013, referenced above, the first or initiating media manager 12 generates a transit ID that uniquely identifies the offsite job request. For example, if the first or initiating media manager 12 has a media movement job that has successfully sent media offsite (i.e., to the offsite media manager 12), the initiating media manager 12 automatically sends to the offsite or second media manager 14 a job request having a unique transit ID.

After producing the appropriate status request, the status interface system 16 polls the second or offsite media manager 14 at step 34 to obtain the status information 18 from the second media manager 14. After having received the poll (i.e., status request) from the status interface system 16, the offsite or second media manager 14 responds to the poll with status information 18. The status information 18 is then received by the status interface system 16 at step 36.

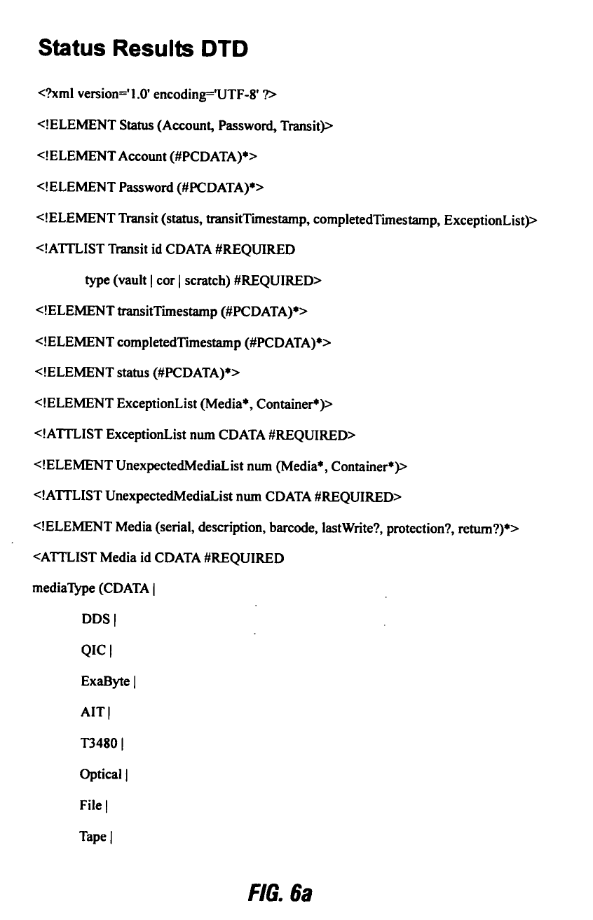

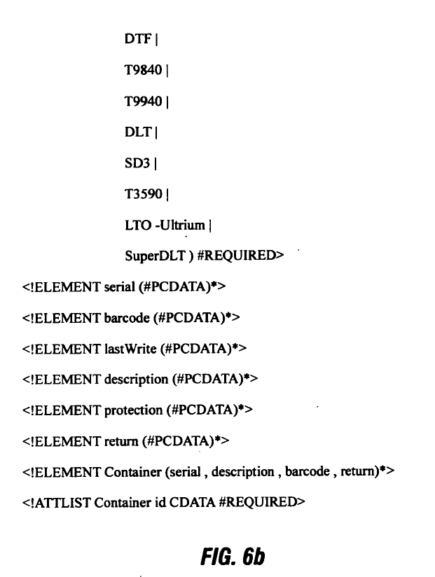

In one embodiment, the status information 18 is based on the standard HTTPS protocol, where status information 18 is in XML format. Exemplary status information files are illustrated in FIGS. 5, 6a, and 6b. Because the HTTPS protocol is capable of communications via proxy servers, it allows the second media manager 14 to communicate the status information 18 through a firewall.

The status information 18 is indicative of the status of the requested job and may include information indicative of the following: That the requested job is running; that the requested job is complete with no information (e.g., no errors occurred that would occasion the provision of additional information); that the requested job is complete with additional information (e.g., as a result of certain errors that may have occurred); that the requested job does not exist; and general errors. In the embodiment shown and described herein, the status information 18 is provided in an XML format. Exemplary status results files are illustrated in FIGS. 5, 6a, and 6b. Alternatively, other file types and formats may be used.

While the status information 18 may be transmitted directly to the first media manager 12, in one embodiment, the status interface system 16 classifies the status information 18 at step 38 to produce classified status information 24 (FIG. 1). As described above, the classification process 38 may be accomplished with the aid of logic 20 available to the status interface system 16.

In the embodiment shown and described herein, the classification process 38 involves assigning one or more return codes to the status information 18 to produce the classified status information 24. As will be described in greater detail below, the return codes comprising the classified status information 24 may be used by the media management system 10 to additionally process the status information 18 to produce supplemental status information 26 or to cause the first media manager 12 to perform additional actions.

In the embodiment shown and described herein, a first return code (e.g., “1”) is assigned if the status information 18 is indicative of a successfully completed job with no additional information. A second return code (e.g., “2”) is assigned if the status information 18 is indicative of a completed job with additional information. A third return code (e.g., “3”) is assigned if the status information 18 is indicative of a parsing error (e.g., if the second media manager 14 could not parse the status request XML file). A fourth return code (e.g., “4”) is assigned if the status information 18 is indicative of a job that is still running. A fifth return code (e.g., “5”) is assigned if the status information 18 is indicative that a status request could not be authenticated (e.g., if the status request contained a bad account number or password). A sixth return code (e.g., “6”) is assigned if the status information 18 is indicative that the requested job does not exist. Alternatively, other return codes and classification systems could be used.

In the case of return code “1” or “2”, the job is marked as complete in the initiating or first media manager 12 and no further status polling will be performed for that specific job. However, additional considerations apply to return codes “1” or “2,” as will be described in further detail below.

In the case of return code “4,” i.e., that the job is still running, the media management system 10 will continue to perform the status polling process. In the case of return codes 3 or 5, the media management system 10 will cause a suitable message to be displayed on the user interface 28 (FIG. 1), although this is not required.

Return code “6” indicates that the original electronic request to create a job that was sent by the initiating or first media manager 12 to the offsite or second media manager 14 failed for some reason (e.g., a network failure). In this case, the media management system 10 will automatically trigger a retry of the original job request, such as, for example, by instructing the initiating or first media manager 12 to resend the job request.

As mentioned above, return codes “1” and “2” create additional considerations and cause additional actions to be performed. For example, when a status request has a return code of “2,” additional information is available. In the embodiment shown and described herein involving the transfer of information in the XML format, the additional information available with the return code “2” is in the form of an XML-formatted results file. Such additional information can include details of the job completion date and time, and also any errors that may have occurred during the execution of the offsite job. Examples of such information are illustrated in FIGS. 5, 6a, and 6b which are sample files entitled “Status Results XML” and “Status Results DTD,” respectively. The “ExceptionList” information in the Status Results XML (FIG. 5) identifies the media in the offsite job that could not be located (i.e., “lost” media). The “UnexpectedMediaList” information identifies media that was found in the offsite job but that was not required by that job (i.e., the incorrect media was sent offsite). In situations where locked containers have been sent to the offsite media manager 14, then the offsite jobs will be moving the entire container into or out of the offsite media manager 14, in which case any lost or unexpected media will be identified in terms of entire containers. It should be noted that the foregoing information is exemplary only, and the media management system 10 should not be regarded as limited to the types of additional information discussed herein.

In the embodiment shown and described herein, the media management system 10 may also perform step 40, which involves evaluating the classified status information 24 and additional processing of the status information 18 in order to produce supplemental status information 26 (FIG. 1). The additional processing of the status information 18 is performed when any status requests indicate a job has completed, i.e., when the return codes of the classified status information 24 are either return codes “1” or “2.” However, the additional processing varies depending on whether the offsite job was storing or returning media.

If the offsite job was storing media, the media management system 10 of one embodiment does the following:
When the original media movement job is marked as complete (i.e., media have been sent offsite), then the job is not closed, but is instead put into a “Waiting or Offsite Completion” status. A user (not shown) can be so notified via the user interface 28 such as, for example, by changing a job status icon (not shown) to a “truck” symbol. In this state, the job can be viewed by the user, but not changed.
If the return code is “1”, the job is marked as complete using the current date/time as the completion time. The media management system 10 may then automatically close the job on the job list.
If the return code is “2,” the media management system 10 parses the status information 18 (e.g., the Status Results XML file, FIG. 5) and marks the job as complete using the job completion date/time from the status information 18 (e.g., the Status Results XML file). The media management system 10 may then automatically close the job on the job list. In addition, any media listed in the “ExceptionList” will be marked as “lost” in the first or initiating media manager 12. If a container is in the “ExceptionList” then all the media in the container will be marked as “lost.” Any media listed in the “UnexpectedMediaList” will be marked as being in that particular offsite or second media manager 14 location. In one embodiment, the unexpected media will be added to subsequent jobs to move the media to its correct location. If a container is in the “UnexpectedMediaList” then all the media in that container is marked as being at the offsite location.

Turning now to the case where the offsite jobs involve returning media, the media management system 10 of one embodiment does the following:
All the media coming from the offsite media manager 14 represents a media “source” for that media movement job. In one embodiment there can be multiple sources of media in a single job. Each media source in the job has a status associated with it, and initially the status for the offsite source is classified by the media management system 10 as “Waiting for Verify” to indicate that the offsite job still needs to locate all of the required media and verify it. Verification can involve scanning a barcode (not shown) or other indication system provided on the media.
If the return code is “1” the media management system 10 marks the media source as complete using the current date/time. So marking the media source as complete means that the offsite job is complete. At this point, the status of the offsite source may be marked by the media management system 10 as “In Transit” to indicate that the media has been shipped back from the offsite media manager 14.
If the return code is “2” the media management system 10 parses the status information 18 (e.g., the Status Results XML file, FIG. 5) and marks the source as complete using the job completion date/time from the status information 18 (e.g., the Status Results XML file). The media management system 10 may then change the status of the outside source to “In Transit” to indicate that the media has been shipped back from the offsite or second media manager 14. In addition, any media listed in the “ExceptionList” will be marked as “lost” in the first or initiating media manager 12. If a container is in the “ExceptionList” then all the media in the container will be marked as “lost.” If one or more pieces of media are in the “ExceptionList” then the status of the offsite source is set to “In Transit with Exceptions” to indicate that not all of the required media has been shipped back from the offsite or second media manager 14.
The offsite source status changes to “arrived” once any of the media returned from offsite is verified (e.g., barcode scanned) at its destination. Note that any media that was marked as “lost” at the offsite media manager 14 may be highlighted in the media list of the job at the destination. This will indicate to a user that if the media cannot be found it is because it was lost at the offsite media manager 14 location. However, if the media is subsequently found (e.g., it was found at another media manager location), then when it is verified in the media movement job at the destination, the media managing system 10 will automatically clear the “lost” status.

Having herein set forth preferred embodiments of the present invention, it is anticipated that suitable modifications can be made thereto which will nonetheless remain within the scope of the invention. The invention shall therefore only be construed in accordance with the following claims:

1. A media management system, comprising:
a first media manager;
a second media manager; and
a status interface system operatively associated with said first and second media managers, said status interface system allowing a status of said second media manager to be communicated to said first media manager.

2. The media management system of claim 1, wherein said status interface system comprises a polling system, said polling system polling said second media manager to obtain the status of said second media manager.

3. The media management system of claim 1, wherein the status of said second media manager comprises a status of at least one media management job.

4. The media management system of claim 1, wherein said second media manager comprises a push system, said push system communicating the status of said second media manager to said status interface system.

5. The media management system of claim 1, wherein said first media manager comprises a policy-based media management system.

6. The media management system of claim 1, wherein said second media manager comprises a policy-based media management system.

7. The media management system of claim 1, wherein said status interface system further comprises logic, said logic classifying the status of said second media manager to produce classified status information.

8. A method for managing a first media management system and a second media management system, comprising:
receiving status information from the second media manager; and
transferring the status information to the first media manager.

9. The method of claim 8, further comprising polling the second media manager for status information before receiving the status information.

10. The method of claim 8, further comprising:
classifying the received status information; and
communicating classified status information to the first media manager.

11. The method of claim 10, wherein classifying the status information comprises assigning return codes to the status information.

12. The method of claim 11, wherein assigning return codes to the status information comprises:
assigning a first return code if the status information is indicative of a successfully completed job with no additional information;
assigning a second return code if the status information is indicative of a completed job with additional information;
assigning a third return code if the status information is indicative of a parsing error;
assigning a fourth return code if the status information is indicative of a job that is still running;
assigning a fifth return code if the status information is indicative that a status information request could not be authenticated; and
assigning a sixth return code if the status information is indicative that a job does not exist.

13. A method for managing at least two media managers, comprising:
using a first media manager to initiate a first job request for a second media manager;
sending the first job request to the second media manager;
receiving status information relating to the first job request from the second media manager; and
resending the first job request to the second media manager if the status information is indicative of a failure of the second media manager to receive the first job request.

14. The method of claim 13, further comprising polling the second media manager for the status information before receiving the status information from the second media manager.

15. The method of claim 14, further comprising:
periodically polling the second media manager for the status information;
receiving the status information; and
re-sending the first job request until the status information indicates that the second media manager has successfully received the first job request.

16. At least one machine-readable medium having stored thereon sequences of instructions, which, when executed by a machine, cause the machine to perform the actions:
receive status information from a second media manager; and
transfer the status information to a first media manager.

17. The medium of claim 16, further comprising instructions to cause the machine to:
classify the status information from the second media manager; and
cause the first media manager to operate in accordance with the classified status information.

18. The medium of claim 16, further comprising instructions to cause the machine to poll the second media manager for status information before the machine receives the status information.

19. The medium of claim 16, further comprising instructions to cause the machine to classify the status information by assigning a plurality of return codes to the status information.

20. The medium of claim 19, further comprising instructions to cause the machine to:
assign a first return code to the status information when the status information is indicative of a successfully completed job with no additional information;
assign a second return code to the status information when the status information is indicative of a completed job with additional information;
assign a third return code to the status information when the status information is indicative of a parsing error;
assign a fourth return code to the status information when the status information is indicative of a job that is still running;
assign a fifth return code to the status information when the status information is indicative that a status information request could not be authenticated; and
assign a sixth return code to the status information when the status information is indicative that a job does not exist.
